(19) United States
(12) Patent Application Publication
(10) Pub. No.: US 2003/0193401 A1
(43) Pub. Date: Oct. 16, 2003

(54) Electronic locating device (ELD)

(76) Inventors: Lynn Pennington, Combs, KY (US); Lamarr Ritchie, Happy, KY (US); Bill Bonds, Canada, KY (US)

Correspondence Address: Lynn Pennington, P.O. Box 194, 562 Hwy 80W., Combs, KY, 41729, US

(21) Appl. No.: 10/120,856

(22) Filed: Apr. 12, 2002

(51) Int. Cl. G08B 3/00

(52) U.S. Cl. 340/691.1; 379/37

(57) ABSTRACT

An automatic device that functions from touch tone dialing of an emergency number such as 911 or a test number to test the system, 211 as used presently. Upon dialing the desired designated emergency number, 911, the system will activate one or two visual strobe lights. (depending on how many lights the owner of the system uses.) The visual signaling strobe lights will serve as an aid in locating an emergency and reduce response time for emergencies and life and death emergencies. The system will continue to signal and function until the unit is reset for future uses, by pressing the reset button on the side of the unit. The unit does not have a telephone connected to it, but the main phone line must be connected and by dialing 911 from any extension telephone or a portable connected to the same line will recognize the tones and activate the signal.

### REFERENCES CITED

U.S. patent Documents:

| | | |
|---|---|---|
| 4,878,236 | Oct. 19, 1989 | Ray et al. |
| 5,880,672 | Mar. 09, 1999 | Weaver |
| 5,621,379 | Apr. 15, 1997 | Collins |

### BACKGROUND OF INVENTION

1. Field of the Invention

The Electronic Locating Device, the present invention, will activate a flashing strobe light or any other significant light after dialing 911 or any other programmed emergency numbers, to indicate the location of an emergency in residential or business locations. The unit is designed to have special programmed number to be used such as in a motel, the number 9 usually has to be dialed to get an outside line and with this unit an extra 9 can be programed which the user will dial 9911 and the unit will activate and indicate the room location of the emergency. For residential use the mergency number 911 will will be used. The unit will activate the strobe light from any phone that is connected to the same line as the ELD unit. For example, if an emergency happens outside of residence or building and 911 is dialed from a portable phone connected to the same line as the ELD unit, then the strobe will be activated to indicate location of emergency.

2. Description of Related Art

In the past, there are other locator devices designed to do a specific task, but the functions are limited to specifics as indicated by the coded type signals and the lighting of house numbers and a timed type setting of the emergency flashing strobe. Such examples are noted in the U.S. paten to Ray et al, U.S. Pat. No. 4,878,236,; Collins, U.S. Pat. No. 5,621,379; and to Weaver U.S. Pat. No. a5,880,672. The present invention is more versatile and has more functions that can be programed to suit residential, business, or special needs in the locating of an emergency type situation.

### SUMMARY OF THE INVENTION

The Electronic Locating Device (ELD), is a device that is made with computer chips and other electronic components, housed in a fabricated box (FIG. 2) with the dimensions of four and one-half inches by three inches by one and three-fourth's inches, (4.5″×3″×1-¾″). The box has special outlets that server for special functions for connections to a standard electric wall outlet and or low voltage battery back up, two connection outlets for the exterior strobe light or strobe lights or other type emergency indicator lights that may become available in future technology, and two phone outlets, one being for the incoming telephone line and the other being to connect a telephone to the unit, which is not necessary since the unit will activate from using any telephone as long as it is connected to the smae incoming telephone line, regardless whether it is a portable phone or a telephone located in another par of the house or outside the house. By this feature, an allowance is made in event there is an emergency outside the house such as the back yard or other areas and a portable telephone is available, the unit can be activated when 911 is dialed. This would save time in event of a life-threatening situation for the notification of an emergency response system and the activation of the unit which will assist the Emergency Response System in locating the emergency. A manual reset button is placed on the unit for the unit to be reset after response, either by the owner's family member or an emergency response member oriented as to the presence of this device. All power source to the unit and the light is of low voltage in nature as a safety feature as to not be a potential hazard of any nature. The box houses a PC board (FIG. 4) makes the Electronic Locating Device (ELD) function. This device has electronic connections to operate one or more strobe lights or other type of lights that may be developed in the future that may be more effective in the location of an emergency situation. The PC board and its functions and with it's many adaptable functions is our claim. Only the incoming telephone line is necessary for this unit to be activated. A telephone does not have to be connected to this unit to activate the unit. Any telephone, being a portable or another phone in another part of the house or building of remote or manual operation whis is connected to the same incoming line as the unit, is all that is necessary to activate the unit which will activate the strobe or strobe lights or other. Once 911 is dialed or any other specified designated emergency number is dialed and the strobe or strobe lights or other is activated, then the telephone can be hung up if desired and the light will keep flashing until the unit is reset. This feature will allow one to notify and activate the Emergency Response System and if needed, hang up and call another party if necessary due to the emergency situation at hand.

The Emergency Locating Device (ELD) has the capabilities of being operated with a battery backup system in case for a power failure, with cellular systems or wireless telephone systems, with a remote or various remote life saving systems, and burgular alarm or other alarm systems. The adaptability of this device is designed and programmable to work with various medical alert systems and burgular alarm systems and monitoring systems that are presently on the market and is adaptable to incorporate any new system that may become available. The device is adaptable to operate with various strobe lights, if someone desires a stronger strobe or one of a lesser degree of intensity. The device is programmable for other activating codes, but basically is programmed to be activated by dialing 911 System and by dialing 911, this immediately on demand activates one or more strobe lights, (depending on how many installed) that range in visivilities from one to three miles, depending on the weather conditions and will assist in locating the site of the emergency and hopefully will reduce response time for emergency situations.

NOTE: The strobe or strobe lights are not part of this invention, however, after reviewing many strobe lights, a select group will be marked with the device. The device cane be adapted to function from a remote. This could have a high impact on individuals who are confined to a bed or wheel chair or other medical disabilities.

### BRIEF DESCRIPTION OF DRAWING FIGURES

The following is reference to the attached drawing and charts of parts list, which include the shipping parts list. The description of each drawing and or chart is indicated. The invention features will become better understood with the accompanying drawings in which:

FIG. 1 is a perspective view of PC board in general to illustrate the location of the parts that are listed on the attached parts list, pages 1, 2, 3, and 4.

FIG. 2 is a perspective view of the housing of the PC board, indicating the molding used and illustrates the location of the telephone line and phone outlets, the power source plug in, the strobe light or strobe lights plug in, the switch on the lateral side for normal operation, which is 911 to activate the strobes or test operations which can be nay number, but at the present 211 is used in demonstration. However, any indicated on the lateral side view is the manual reset switch to reset the unit once activated and the response is made.

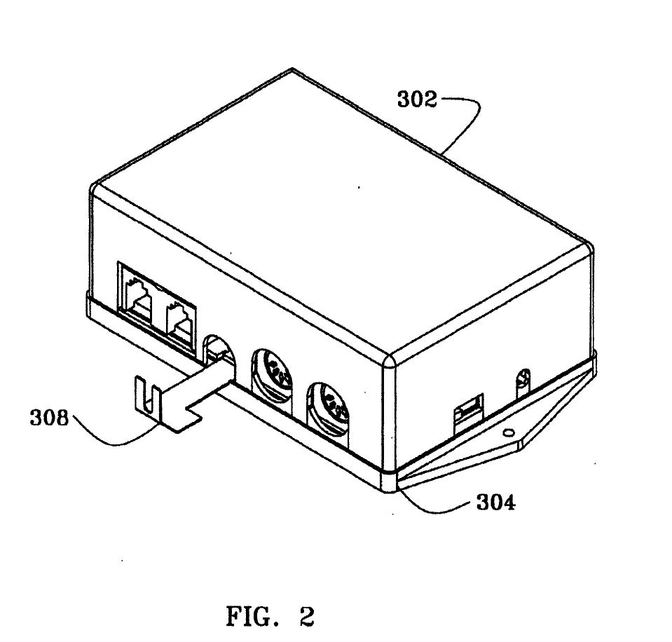

FIG. 3 is a perspective view of the back of the unit displaying the telephone input and telephone plug in line(which it is not necessary for a telephone to be plugged into the unit), the power supply plug in and the power supply plug in guard, and the indicated is a view of the strobe light receptacles for one or two strobe lights. Also the mounting wings to mount the box or housing to t he wall or a fixed area is displayed.

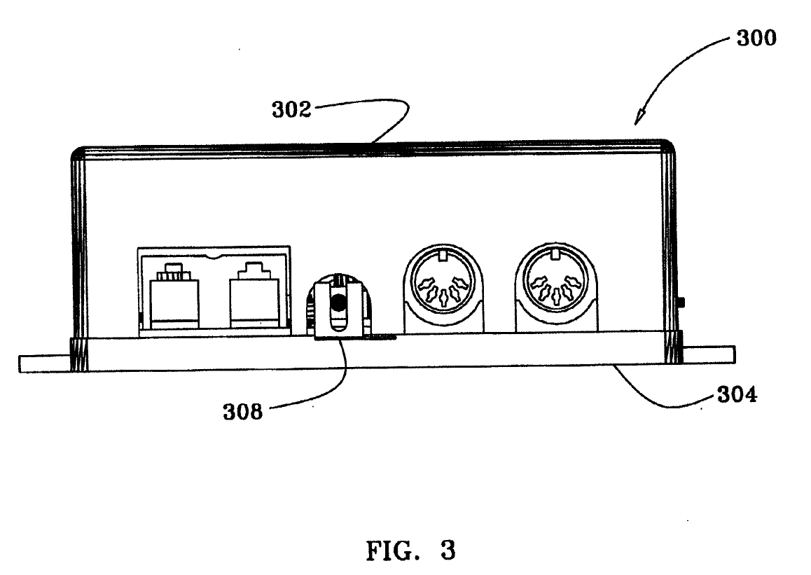

FIG. 4 is a view of the schematic diagram indicating the circuits that perform the various functions as described in the area titled “Circuit Description”.

FIG. 5 indicates a view in general how the unit would be connected in a house or building. Also the relation to the unit and a strobe light is depicted.

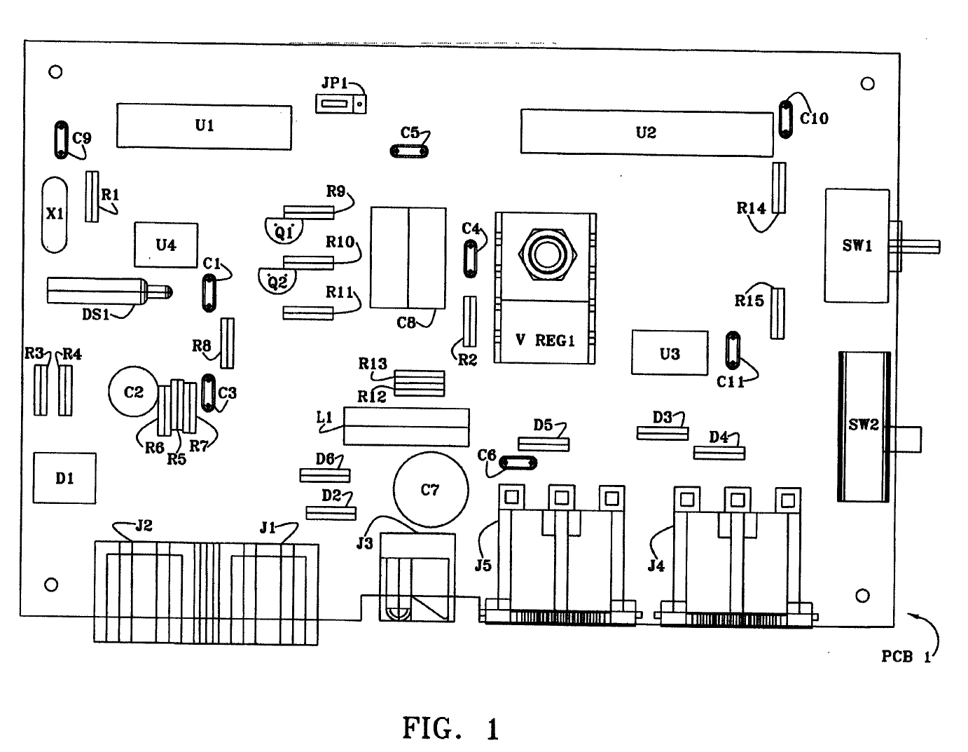

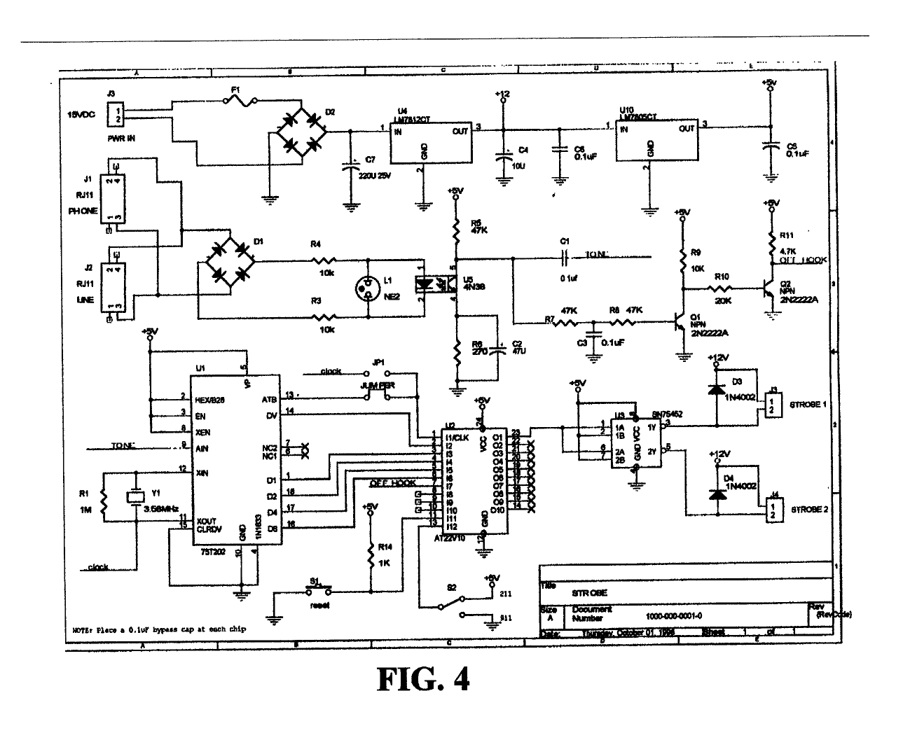

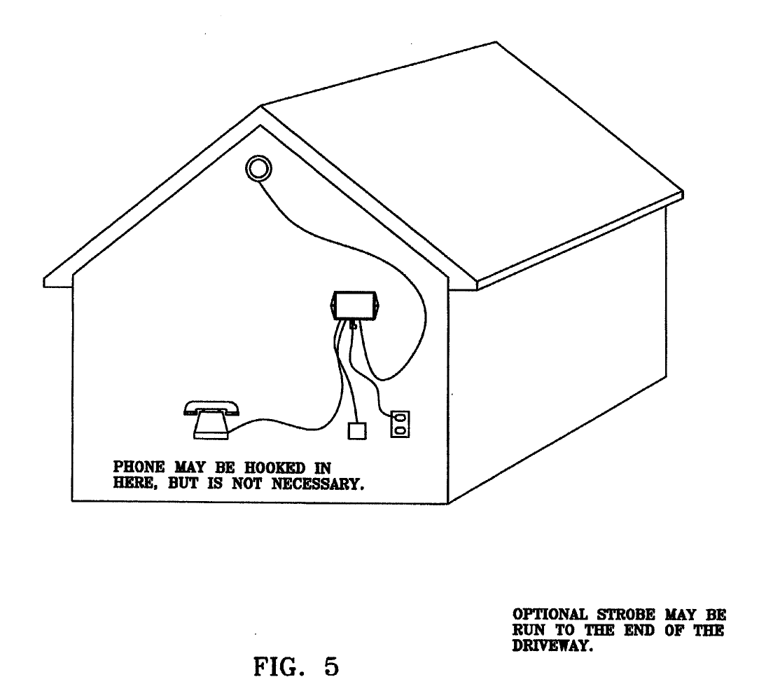

Parts List Page 1, 2, 3, and 4 identify the parts in relation to t he parts location drawing as indicated in FIG. 1 and the Schematic Diagram in FIG. 4.

Shipping Parts is a lisst of parts that are shipped with the unit for installation of the unit. All necessary part to install and make the unit function are shipped with the unit.

### DETAILED DESCRIPTION

Circuit Description

Power Supply:

Power for the unit consists of an external 120 VAC-12 VDC adapter. The adapter outputs approximately 15 VDC into J3 on the main unit. A fuse F1, Provices overload and circuit protection. A bridge rectifier, D2, provides polarity correction in the event that the leads are reversed from the adapter. C7, C4, C8 and C5 provide additional filtering and bypassing. U4 is a 12V regulator for the voltage that will be provided to the strobe light(s). The output of U4 connects to U10 which is a 5V regulator providing the required voltage to all internal circuitry.

Phone Line Interface

The phone line input begins at J1 and J2 connected in parallel. Either may be used to connect the phone line and the other to connect a telephone. The phone line is rectified through D1 in order to use the DC to drive an off-hook detector circuit. Two 10K ohm resistors, R3 and R4 are used to provide the proper impedance match to t he phone line. A neon lamp, L1 is used as over voltage and ringing voltage suppression. Necessary isolation of the circuitry from the phone line is accomplished by U5, and optoelectronics isolator.

Off Hook Detector:

The output of U5 is fed to a resistor network consisting of R5, R6, R7 and R8 that provides the proper bias voltage to Q1, and NPN transistor, such that it will conduct heavily when the voltage is higher (on-hook condition) and near or at cutoff when the voltage is lower (off-hook condition). This DC voltage is fed to Q2 which acts as a digital saturated switch. This gives a h/lo output of near 0V and 5V. This output will provide a low when phone is off-hook and a high when on-hook. Capacitors C2 and C3 provide filtering and bypassing as necessary. R9, R10, and R11 provide the proper bias voltages and currents for Q2.

Dial Detection and Decoding:

The dial tones from the phone line take the same route as the DC voltages described above up to the output of U5. At this point, the AC voltages (dial tones) are coupled through C1 to AIN of U1. U1 is a 75T202 dial tone detector/decoder that converts the DTMF phone codes to 4-bit binary code. Crystal Y1 and resistor R1 provide the 3.58 Mhz internal clock reference for this chip.

The 4-bit binary code output by U1 is connected to inputs 13 through 16 of U2. U2 is and Atmel AT22V10 Programmable Logic Device (PLD). Other inputs provided to u2 are reset (provided by switch S1 and resistor R14), the output of a test/norm switch, S2, the output of the OFF-HOOK circuit described above and the DV (data valid line from U1 used to count the numbers dialed. U2 is programmed with all the logic to:

1. Reset and begin operation when the phone is taken off hook.

2. Detect when the numbers “911” (norm) and “211” (test) are dialed.

3. Count the number of codes input to insure only three numbers are dialed.

4. Reset and turn off strobe when S2 (reset) is pressed.

Strobe Driver:

Output O1 from U2 is connected to both inputs of U3, and SN76452 Dual Peripheral Interface Driver. These are activated when the output of U2 goes low and provides enough current to drive a strobe or strobe lights. The output of each connect to separate jacks so that either one or two 12V strobe lights can be connected. Diodes D3 and D4 are connected across the output jacks to prevent negative voltage spikes from the strobe lights from damaging U3.

PARTS LIST

| Ref. Designator | Qty. | Description |
|---|---|---|
| C1, C3, C4, C5, C6, C9, C10, C11 | 8 | 0.1 uF |
| C2 | 2 | 47 uF, 35 v |
| C7 | 1 | 220 uF 35 v |
| C8 | 1 | 470 Uf 16 v |
| R1 | 1 | 1M ohm ¼ w |
| R2 | 1 | 2.7K, ¼ w |
| R3, R4, R9 | 3 | 10K, ¼ w |
| R5 | 1 | 24K, ¼ w |
| R7, R8 | 2 | 47K, ¼ w |
| R6 | 1 | 270 ohm |
| R10 | 1 | 20k, 1/4 w |
| R11 | 1 | 4.7K, ¼ w |
| R12 | 1 | 2.8K, ¼ w 1% |
| R13 | 11 | 22K, ¼ w 1% |
| R14, R15 | 2 | 1K, ¼ w |
| D1 | 1 | DB101 |
| D2, D3, D4, D5 | 4 | 1N4002 |
| D6 | 1 | 1N5819 |
| DSI | 1 | NE2 lamp |
| U1 | 1 | (CD22202E) OR (75T202) |
| U2 | 2 | ICT22CV1OAP-10 |
| U3 | 1 | SN75428P |
| U4 | 1 | 4N38A |
| VREGI | 1 | (MAX727CCR) OR (MAX |
| | | 724CCK) OR (MAX726CCK) |
| X1 | 1 | 3.59545 MHz |
| F1 | 1 | Jumper wires |
| Jp1 | 1 | 3 Pin Header |
| L1 | 1 | 100 uH |
| Q1, Q2 | 2 | 2N2222 |

| Part No. | Loc. | Qty. | Description |
|---|---|---|---|
| | U1 | 1 | CD2202E |
| | U2 | 1 | 1CT22CV10AP-10 |
| | U3 | 1 | SN75428P |
| | U4 | 1 | 4N38A |
| | U5 | 1 | |
| | D1 | 1 | BRIDGE RECTIFIER |
| | | | DB101 |
| | D2, D3, D4, | 5 | 1N4004 DIODE, |
| | D5 | | 1 AMP |
| | D6 | 1 | 1N5819 DIODE |
| | C1, C3, C4, | 8 | 0.1 Uf DISC CERAMIC (XTR) |
| | C5, C6, C9, | | (EMP CORF) CAPACITOR |
| | C10, C11 | | |
| | C2 | 1 | 47 uF 36 v ELECTRIC CAP |
| | | | RADIAL |
| | C7 | 1 | 220 uF 35 v ELECTRIC CAP |
| | | | RADIAL |
| | C8 | 1 | 470 uF 16 v ELECTRICAL CAP |
| | | | RADIAL |
| | R1 | 1 | 1M OHM ¼ W RES 1% |
| | R2 | 1 | 2.7K OHM ¼ RES 5% |
| | R3, R4, R9 | 3 | 10K OHMS ¼ w RES 5% |
| | R5 | 1 | 24K OHM ¼ W RES 5% |
| | R7, R8 | 2 | 4.7K OHM ¼ W RES 5% |
| | R6 | 1 | 270 OHM ¼ W RES 5% |
| | R10 | 1 | 20K OHM ¼ W RES 5% |
| | R11 | 1 | 4.7K OHM ¼ W RES 1% |
| | R12 | 1 | 2.8K OHM ¼ W RES 1% |
| | R13 | 1 | 2.2K OHM ¼ W RES 1% |
| | R14, R15 | 2 | 1K OHM ¼ W RES 5% |
| | DSI | 1 | NE2 LAMP |
| | VERG 1 | 1 | #4 40 LOCK WASHER |
| | VERG 1 | 1 | #4 40 X ⅜ SCREW, PAN, PHIL |
| | | 1 | #4 40 HEX HP NUT |
| | VERG 1 | 1 | VOLTAGE REG. MAX (727CCK) |
| | | | OR (727CCR) OR (726CCK) |
| | VERG 1 | 1 | HEAT. SINK |
| | X1 | 1 | CRYSTAL, 3.579545M1 + Z |
| | | | (XTAL) |
| | JP1 | 1 | 2 PIN SHENT (AMP 1N # 531220- |
| | | | 100) |
| | JP1 | 1 | 3 PIN HEADER (AMP 103741-3) |
| | L1 | 1 | DOLE 1HO-1.100 uH (9829) |
| | | | INDICATOR, RED 100 uH |
| | Q1, Q2 | 2 | TRANSISTOR 2N2222A |
| | J4, J5 | 2 | DIN CONN, #DS-115 (POWER |
| | | | DYN, INC) |
| | J3 | 1 | D.C. POWER (JACK #DC-0010-B- |
| | | | RRPN, 2.5 DIA PIN) POWER DYN, |
| | | | INC. |
| | J1, J2 | 2 | MODULAR TELEPHONE JACK |
| | | | MOLEX #62018-5445 |
| | SW2 | 1 | SLIDE SW., ALCO #MSS-1200R |
| | SW1 | 1 | PUSH BT. SW. GRAY HILL #39- |
| | | | 251/RED |
| | F1 | 1 | JUMPER WIRE |
| | VERG 1 | AR | TRERMAL GREASE |

SHIPPING
PARTS

| | |
|---|---|
| 1 | BASE, PVC |
| 1 | HOUSING, PVC |
| 1 | DECAL “ELD” |
| 1 | POWER SUPPLY, 120 vac 22 w |
| | 60 hz 1N 12 v DC 1 A OUT |
| 1 | STROBE LIGHT SELO ALARM |
| | SL720 |
| 1 | POWER CABLE W/ADAPTER, |
| | 50′ LONG, 2 COND |
| 1 | POLYBAG, 2 MIC 10″ × 12 ″ |
| 1 | TELEPHONE CABLES, 14 Ft |
| 2 | SCREWS # 5 × 1″, STEEL |
| 2 | WALL ANCHORS # 6 × 3/4 |
| 2 | NUT, “BLUE CODE” |
| 1 | POLY BAG 1 MIL 2″ × 2″ |
| 1 | SOFT, PINK WRAP BUBBLE |
| 1 | CARTON, 200 TEST, 12″ × 6″ 4″ |
| 1.5 FT | TAPE, 3″ CLEAR |
| AR | SEALENT |
| | SRINK TUBE |
| 4 | |
| 1 | |

What is claimed is:

1. An electronic device to signal the location of an emergency comprising:
a) upon dialing 911 the signal will activate one or more strobe lights to indicate the location of an emergency and upon dialing 211 to use as a test number for the proper functioning of the unit;
b) only the incoming telephone line has to be connected to the system which enables any extension or portable phone to activate the system;
c) when system is activated, it will continue to function until the unit is reset by pressing a reset button;

2. The electronic device is adaptable and capable of functioning in locating an emergency in other functioning modes comprising;
a) capable of working with a remote and or in a wireless mode;
b) with the use of a battery back up in event of power failure;
c) programmable for business and motel usage by adding another digit to obtain an outside line to dial the emergency number;

3. The device can be adapted to function with cellular phones in a wired mode or a wireless mode.
